(19) United States
(12) Patent Application Publication
(10) Pub. No.: US 2018/0082607 A1
(43) Pub. Date: Mar. 22, 2018

(54) Interactive Video Captioning Program

(71) Applicant: Michael Everding, Santa Monica, CA (US)

(72) Inventor: Michael Everding, Santa Monica, CA (US)

(21) Appl. No.: 15/269,813

(22) Filed: Sep. 19, 2016

(51) Int. Cl. G09B 19/04; G10L 15/02; G10L 15/26; G10L 25/90; G10L 25/51; G10L 15/22; G09B 5/06

(52) U.S. Cl. CPC G09B 19/04; G10L 15/02; G10L 15/26; G10L 2015/025; G10L 25/51; G10L 15/22; G09B 5/06; G10L 25/90

(57) ABSTRACT

An interactive computer assisted pronunciation learning system which allows a student to compare his/her pronunciation with that of a model speaker on video and to replace the model speaker's voice in the video with the student's own interaction of the model's dialog. A model speaker's recorded reading of a text is digitally linked to and aligned with each corresponding syllable of the text. Pitch, volume, and duration parameters of each syllable are extracted digitally and displayed in a simplified notation above each word. The student's own speech is also recorded, analyzed, displayed, and/or replaced in same manner. In addition to the option of replacing the audio system of the model speaker's dialog with the student's own, the student can choose the option of overlapping his/her own notations above those of the model speaker and determine whether, to what extent, and on which parameters his own speech varies from that of the model speaker. Scores may be provided in the margin denoting the percentage/degree of correct correspondence to the model as well as the type and degree of each error.

### BACKGROUND OF THE INVENTION

### 1. Field of the Invention

The present invention relates to a computerized, interactive pronunciation learning system wherein the pitch (frequency), volume (amplitude) and duration of a model speaker's reading of text is encoded digitally and compared with the encoded pitch, volume, and duration of a user's speech, provision being made for immediate real-time display of the results such that the user can visually and audibly ascertain the abstracted differences between the model's and user's speech parameters and choose to replace the video's on-screen model speaker's voice with the student's own iteration of the same dialog.

### 2. Description of the Prior Art

Computer assisted language learning systems have been disclosed in the prior art. For example, U.S. Pat. No. 5,010,495 to Willetts discloses, inter alia, a system wherein a student can select a model phrase from text displayed on an electronic display, record in digitized form his own pronunciation of that phrase and then listen to the digitized vocal version of the selected phrase and his own recorded pronunciation for comparison purposes. The background section of the '495 patent describes a number of other prior art computer assisted language learning systems. For the sake of brevity, the prior art description set forth in the '495 patent will not be repeated herein.

Although the prior art systems include various features necessary for providing visual text displays and associated digitized audio speech and the '495 patent discloses a system which allows a student to select a model phrase from text displayed on an electronic display, record his own pronunciation of that phrase and then listen to the digitized vocal version of the selected phrase and his own recorded pronunciation for comparison purposes, the comparison is accomplished without having the option to replace extensive segments of the model's speech in the digitally captioned video with the student's own voice synchronized and repeating the same dialog. The prior art systems do not have a graphic visual representation nor any objective comparison of the differences.

U.S. Pat. No. 6,336,089, although providing an interactive computer assisted pronunciation learning system which allows a student to compare his/her pronunciation with that of a model speaker, the patent does not disclose how captions already embedded in video can be transformed into interactive captions in real time nor how to replace the captioned voice of a character in a video with a user's or student's voice.

What is desired is to provide an interactive video captioning program which allows video captions to be transformed into interactive captions in real time and also enables the captioned voice of a video character to be replaced with a user's or student's voice.

### SUMMARY OF THE INVENTION

The present invention provides an interactive computer assisted pronunciation learning system which allows a student to compare his/her pronunciation with that of a model speaker and to replace extensive segments of the model speaker's words from the original video with the student's recorded voice speaking the same words and linked to the same time sequence, now on the new interactive version of the original video with selectable captioned text displaying two, three, or four levels of accented syllable pitch, volume, and duration. The model speaker's reading of a text selection is digitally linked to each corresponding syllable segment of text. The student's own speech, repeating the model's words, is also recorded and linked to and aligned with the model's. The student's speech record is analyzed, displayed and/or replayed in the same manner as the model. Pitch, volume, and duration parameters of each syllable are simultaneously extracted digitally and displayed in a simplified “musical” type isolation above each word in real time, as they are spoken by either speaker. Those parameters are synchronized to the model's and the student's speech streams and stored for optional replay of extracted tones or as segments of any length of the student's own iteration of the model's dialog. In addition to replaying the new interactive video with the student's words replacing those of the model speaker, the student can choose the option of overlapping his/her own notation upon that of the model speaker and determine by inspection of the interactive captioned text, where his/her own speech varies from that of the model speaker, to what degree, and on which parameters. When selected from the menu, scores are displayed in the margin denoting the percentage of correct correspondence to the model as well as the type and degree of each type of error by line, paragraph, and page.

The present invention thus improves upon existing interactive computer assisted learning systems by providing an easily used software program which links and aligns a student's speech record digitally to the speech record of a model for comparative processing and which enables a student to visually compare the characteristics of his/her speech, such as pitch, volume, and duration with that of a model speaker and to specify the percentage of correspondence between the student's pronunciation and that of the model speaker. The interactive audio-video (such as in karaoke) feature can replace the model's speech segments with the same segments spoken by the user, and thus allow the user to hear his/her own speech precisely linked to the model's speech as if it were spoken by the model speaker in the video.

### DESCRIPTION OF THE DRAWINGS

For a better understanding of the present invention as well as other objects and further features thereof, reference is made to the following description which is to be read in conjunction with the accompanying drawing therein:

FIG. 1 is a schematic block diagram of an interactive pronunciation learning system in accordance with the teachings of the present invention; and

FIGS. 2-28 are schematic software flow charts or WINDOW displays illustrating the features of the present invention.

### DESCRIPTION OF THE INVENTION

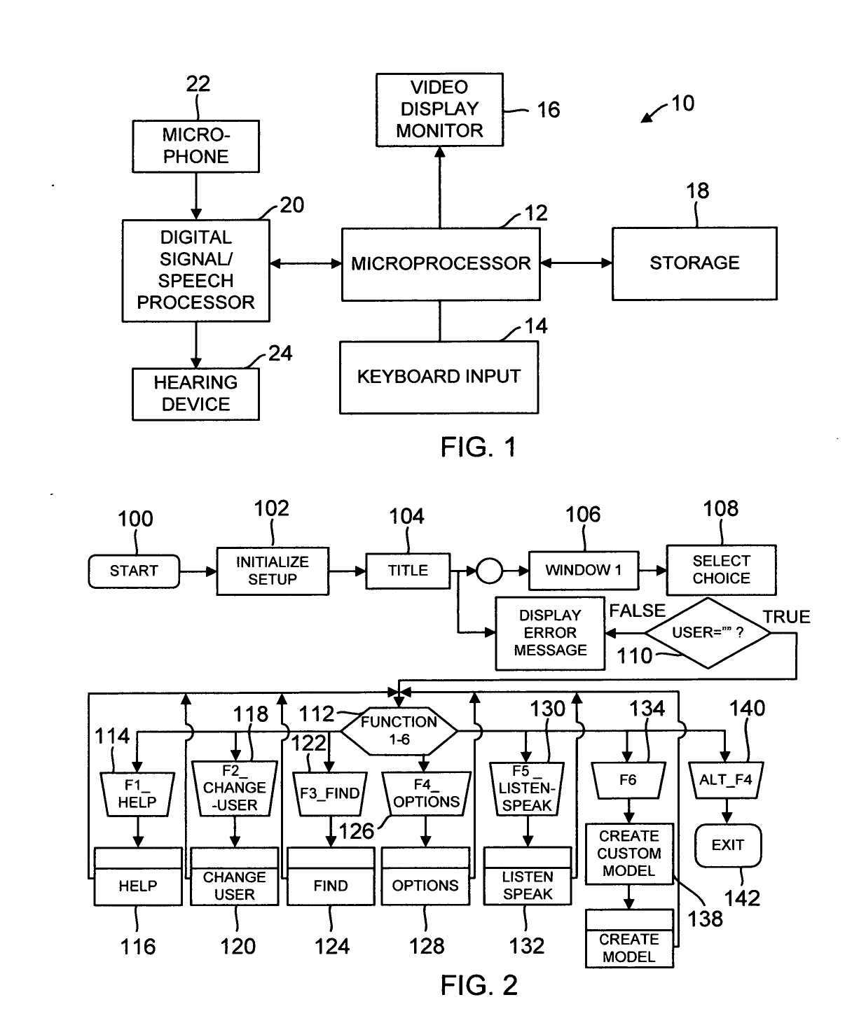

Referring now to FIG. 1, a simplified schematic block diagram of the system 10 of the present invention is illustrated. The system comprises microprocessor 12, such as the Intel Core i7 Skylake manufactured by Intel Corporation, Santa Clara, Calif., keyboard input 14, video display monitor 16, digital storage member 18, a digital signal speech processor 20, such as the Texas Instruments TMS320Cxx manufactured by Texas Instruments, Dallas, Tex., microphone 22 and hearing device 24. Components 14, 16, 18, 22 and 24 are conventional and thus will not be set forth in detail herein.

In operation, a model speaker's reading of any text within a video or via microphone 22 is digitally linked to each corresponding syllable of text by digital signal speech processor 20, microprocessor 12 and storage means 18. The pitch, volume and duration parameters of each syllable are extracted digitally, stored temporarily with the original video as a component in a new interactive digital video file and displayed as enhanced captions synchronized syllable-for syllable with the original video on the interactive video image by member 16 in a simplified notation above each word and/or replayed as tones by the computer. The student's own speech repeating the model's dialog is recorded via digital signal speech processor 20, microprocessor 12 and storage means 18 and are displayed by member 16 in a simplified notation, overlapping the notation of the model speaker to determine whether his own speech varies from that of the model speaker in one embodiment. In a second embodiment, scores are provided in the margin on display 16 in a manner to show the percentage of correct pronunciation when compared to the model as well as the type and degree of each error. In a third embodiment, the extracted elements of pitch, volume and duration may optionally be replayed as tones via microprocessor 12. In a fourth embodiment, the student's iteration of the model speaker's dialog replaces the model's voice in the video, with or without any or all of the graphic enhancements of the captioned text as in the other three embodiments.

Referring now to FIG. 2, a flow chart for the software used in the system of the present invention is illustrated.

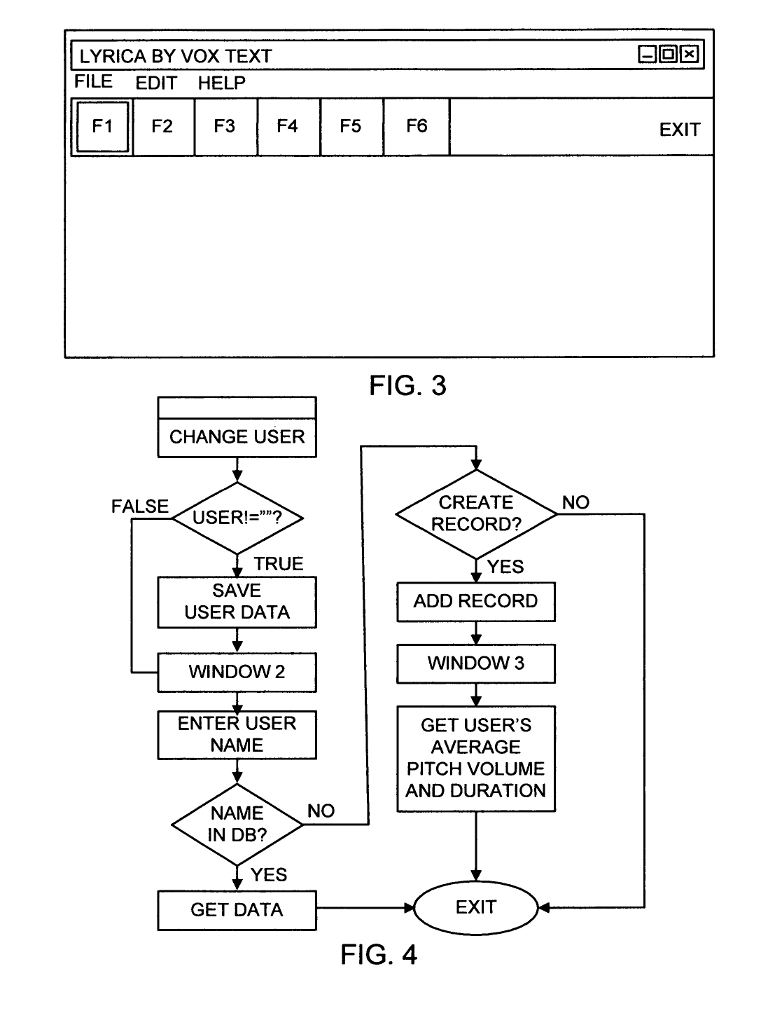

The system is started when the power is applied (step 100), the system is initialized (step 102), the title of the running software is displayed (step 104), the window video display (step 106, FIG. 3) has a select choice displayed thereon (step 108) and a comparison is made (box 110) to ascertain that the proper user is on line.

If the correct user is online, the user selects one of six functions (step 112) in the form of function selections on the WINDOW display. The first function is HELP (step 114), which displays that term (step 116); the second function is CHANGE USER (step 118) which then gets the change user to log on (step 120); the third function is FIND (step 122) and the associated find function (step 124); the fourth function is OPTIONS (step 126) and the associated option function (step 128); the fifth function is LISTEN/SPEAK (step 130) and the associated listen/speak function (step 132); and the sixth function (step 134) initiates the custom model (step 136) which in turn creates the custom model (step 138). The last function, ALT F4 (step 140), carries to the main exit function (step 142) and the program end.

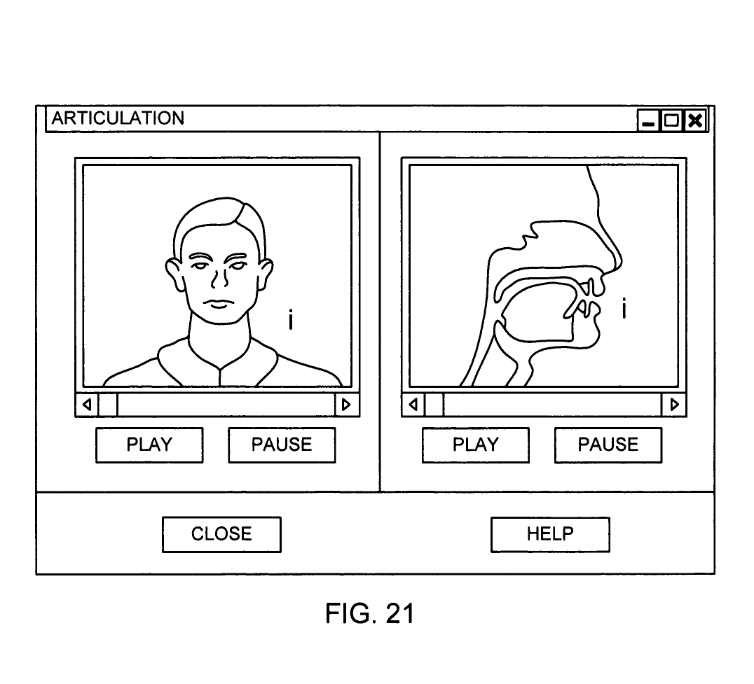

FIGS. 4-28 include the specific software subroutines utilized in the present invention. The figures also include certain WINDOW displays and specific routines for preparing the user notes and scores.

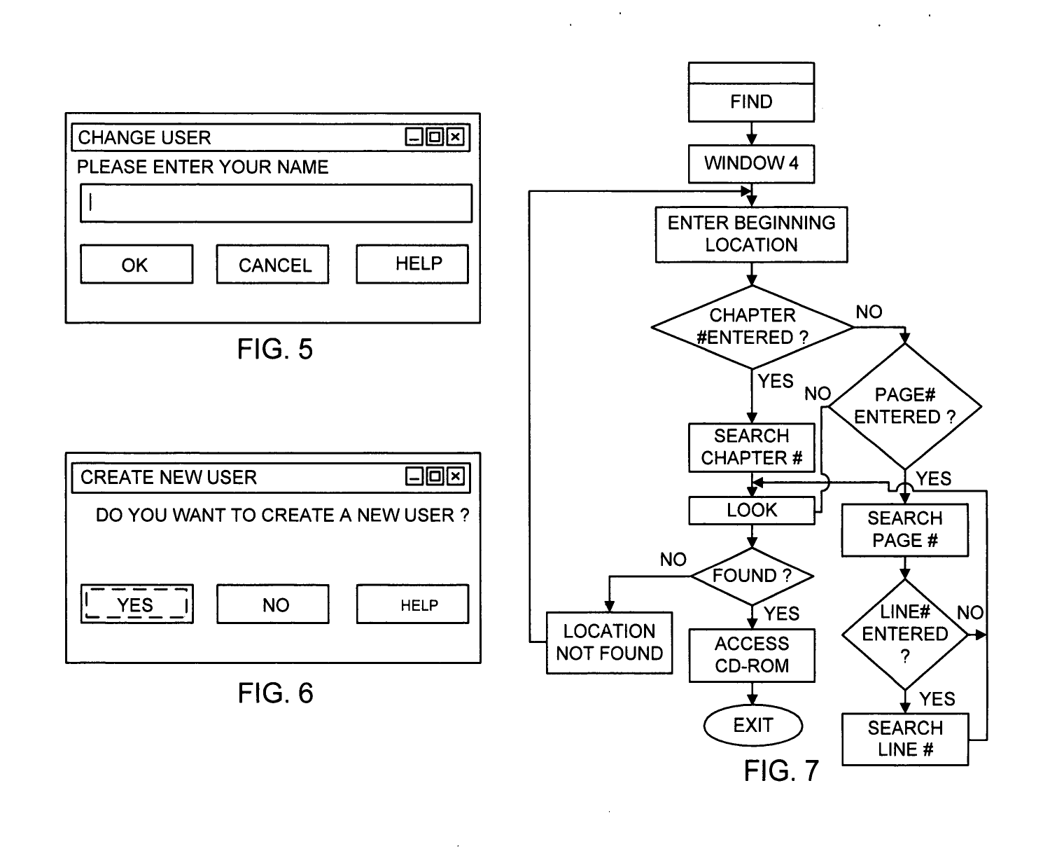

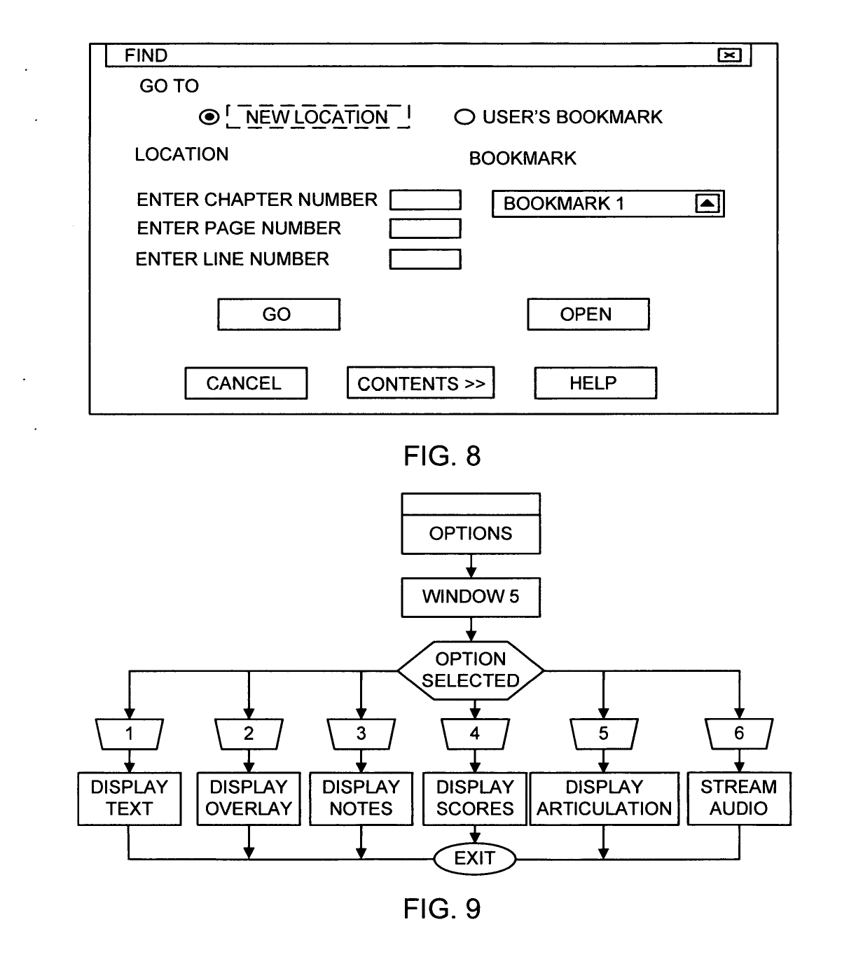

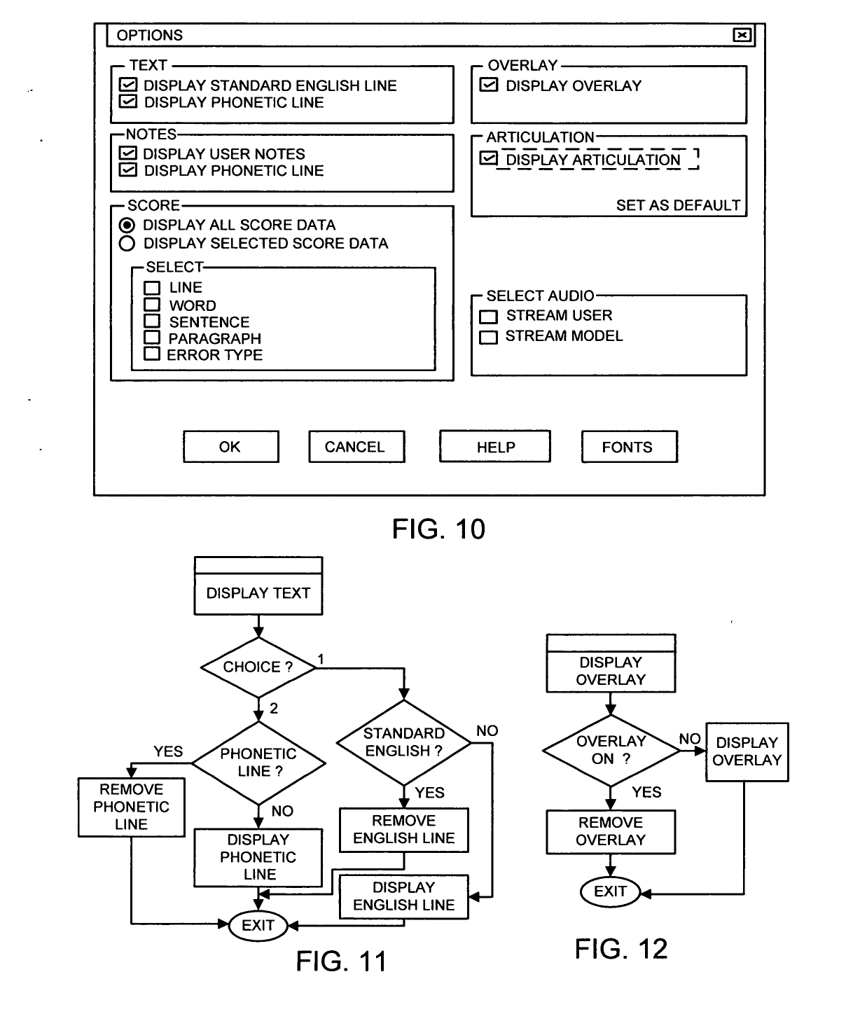

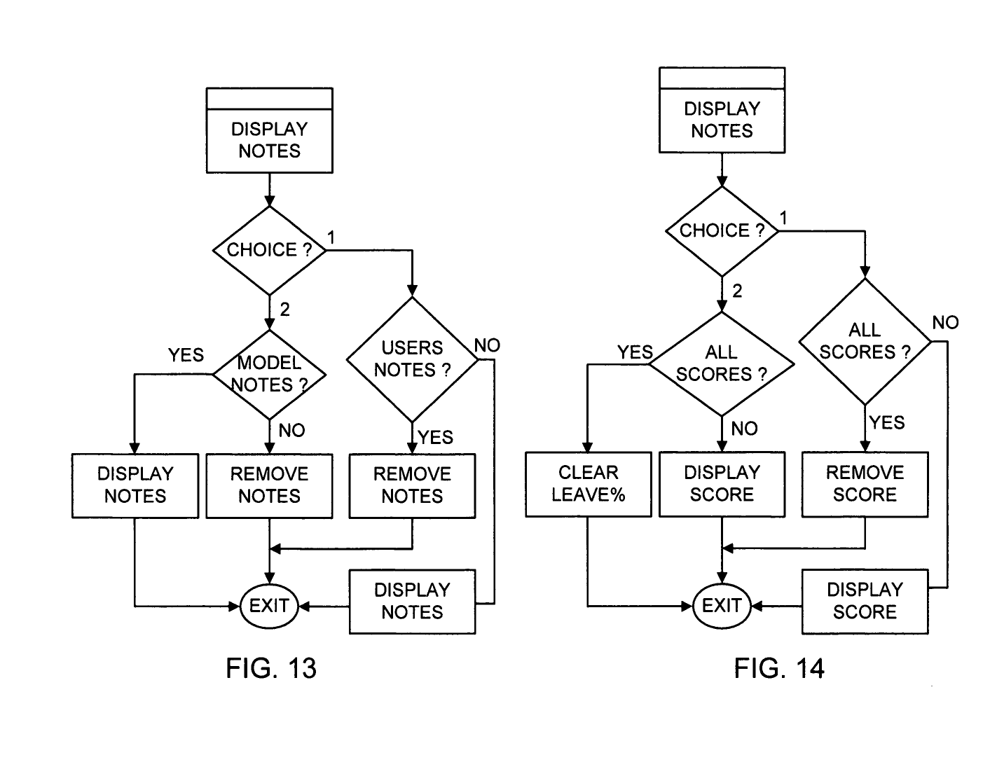

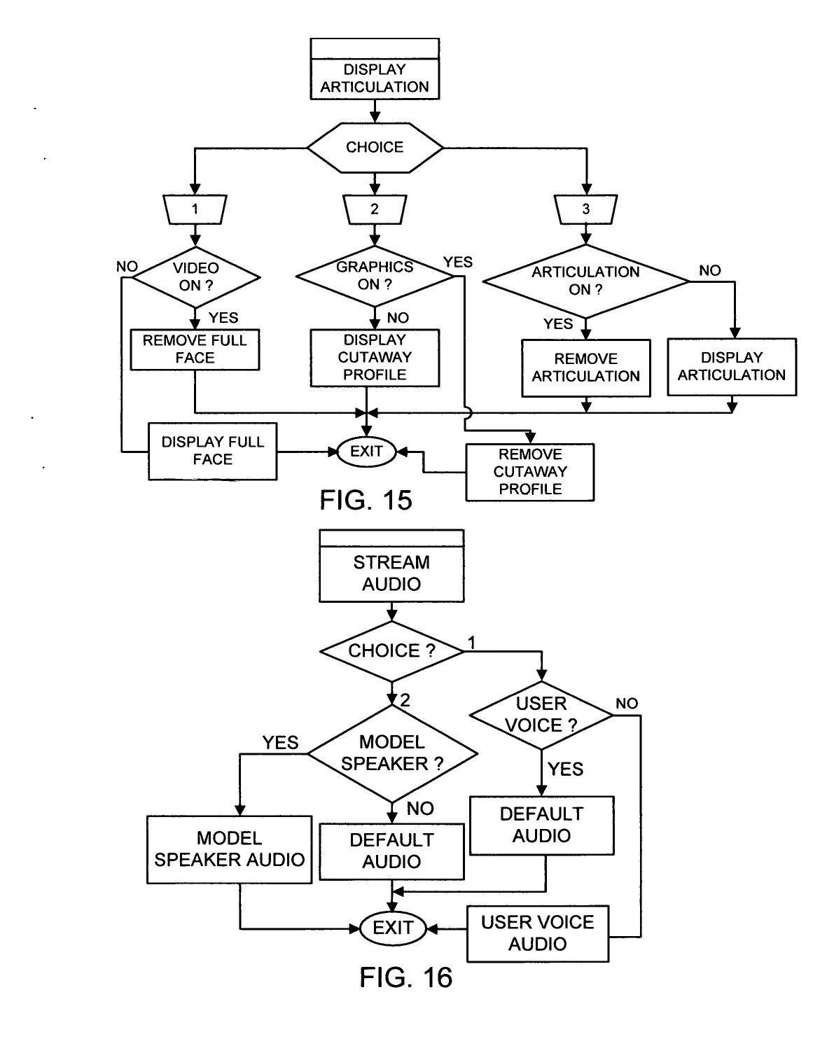

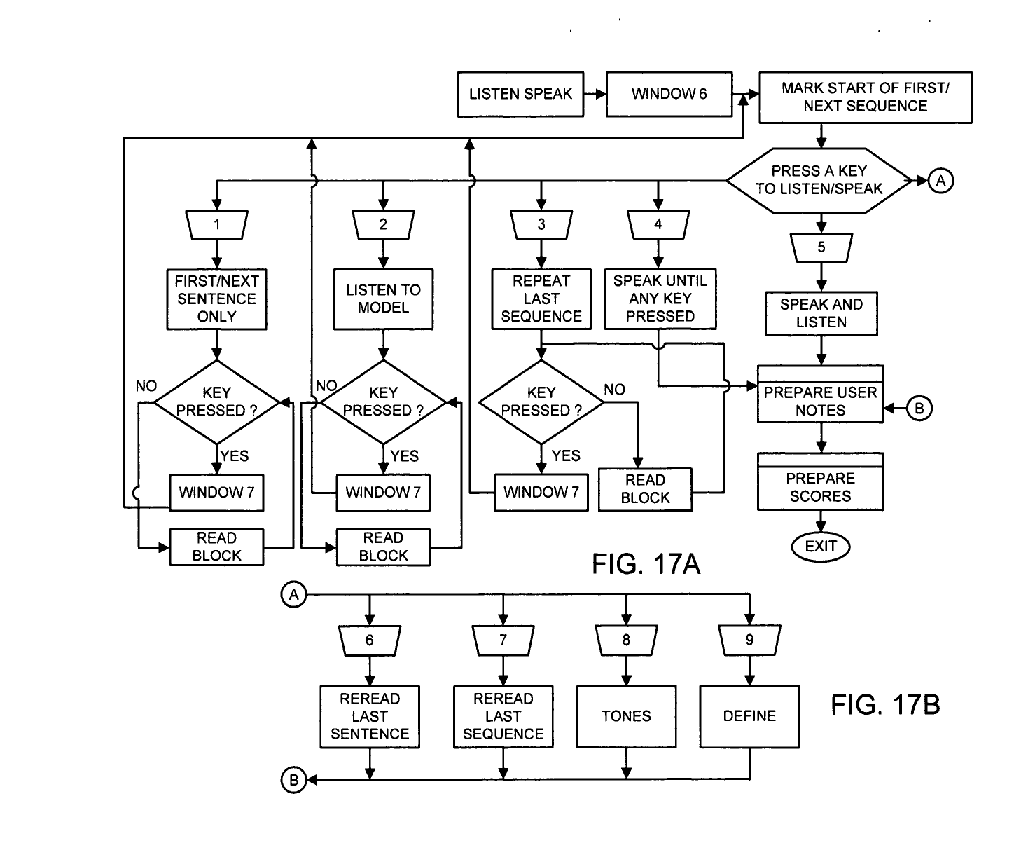

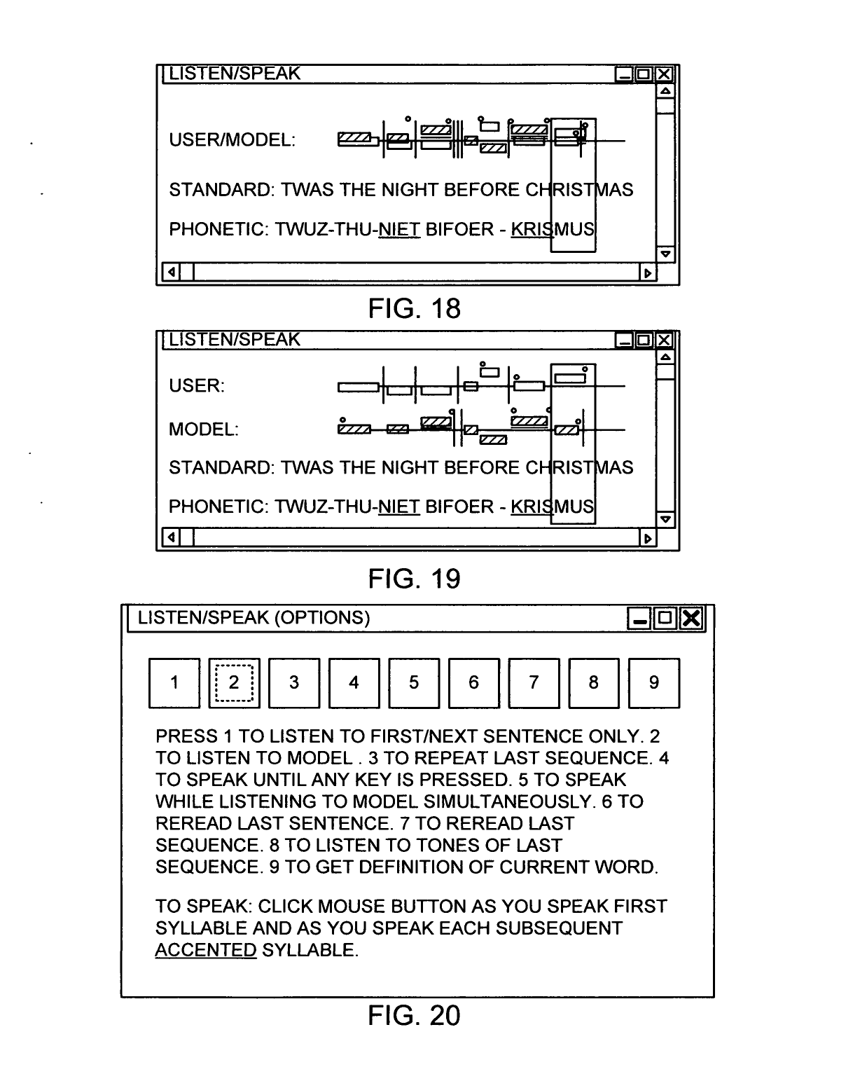

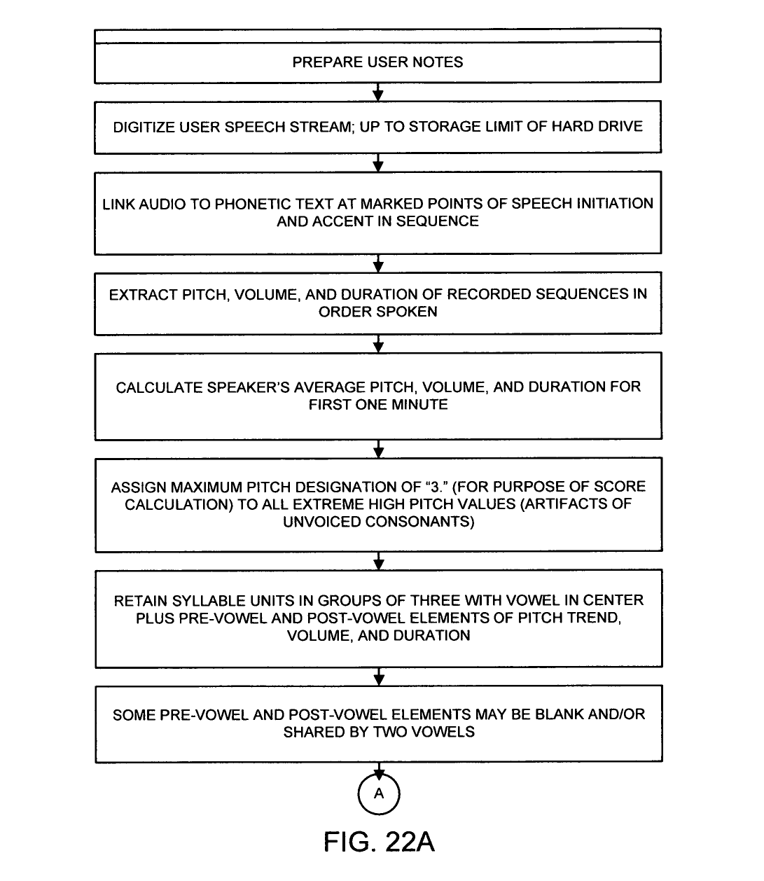

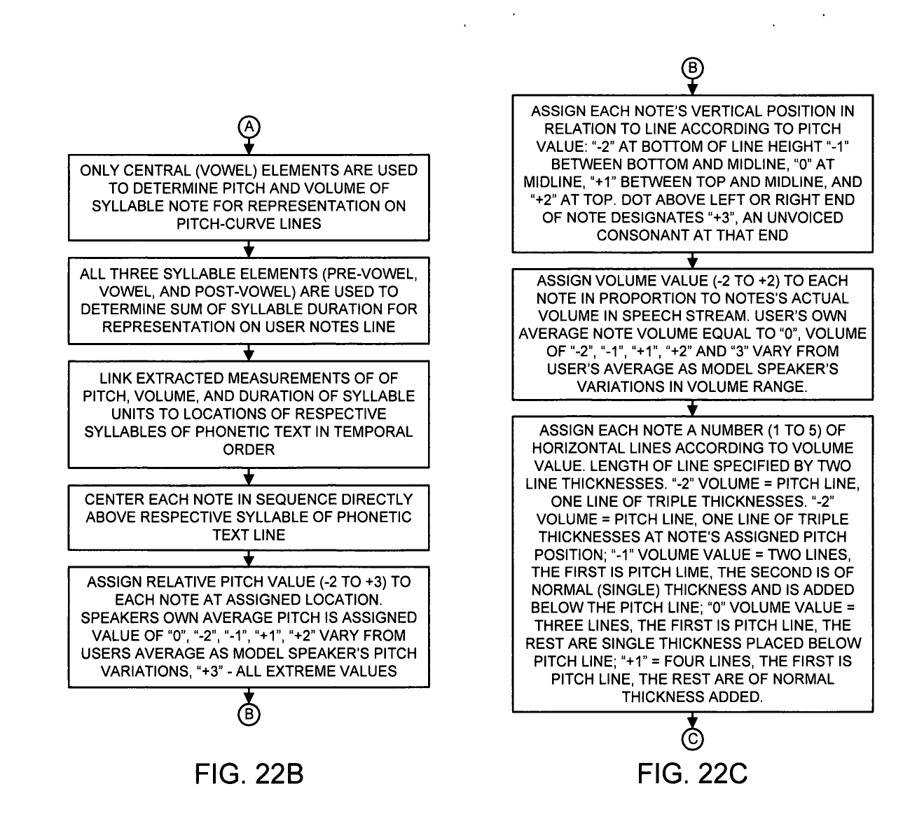

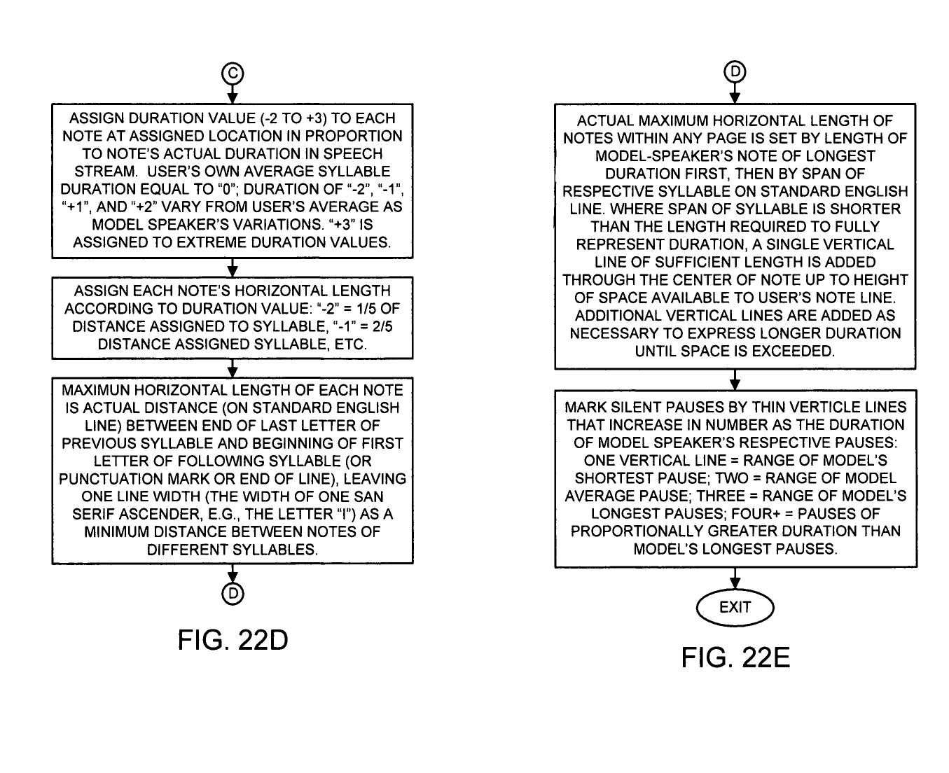

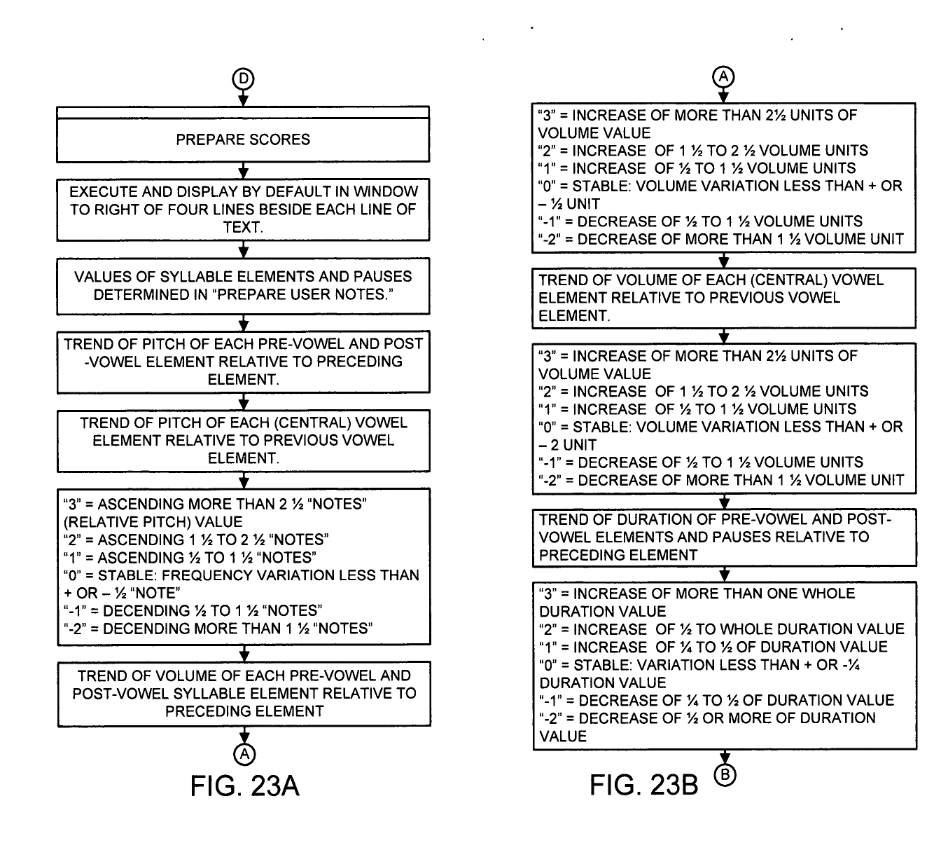

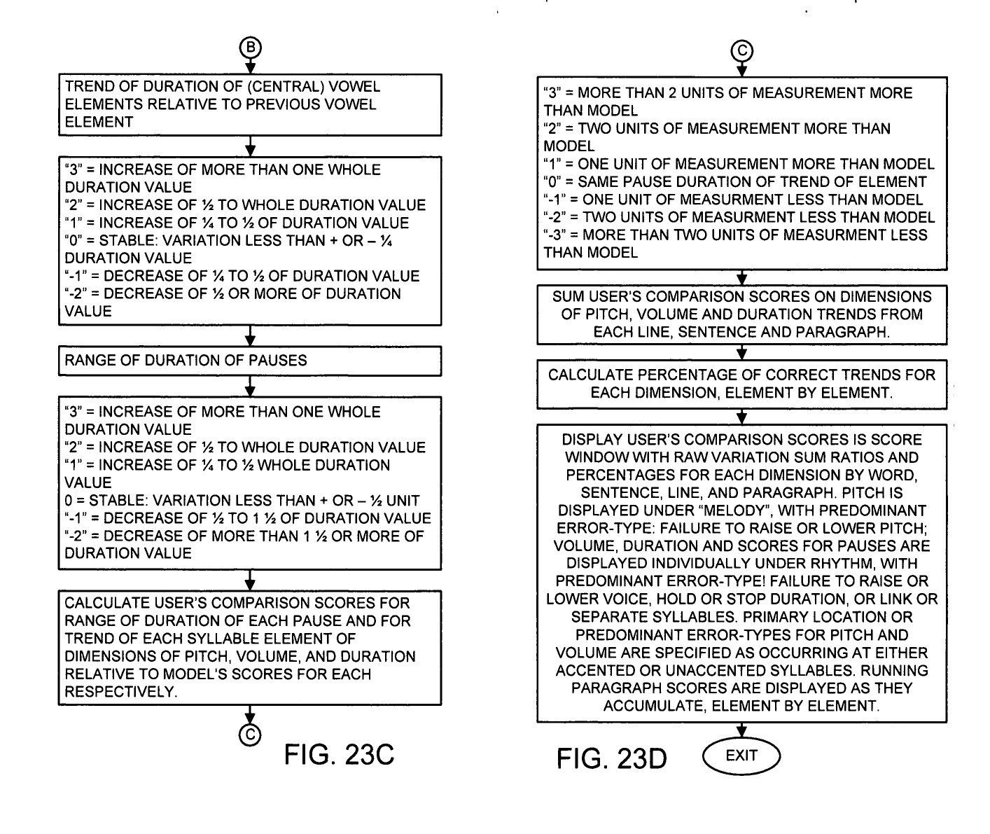

In particular, FIG. 3 is the first WINDOW display (main menu); FIG. 4 is the subroutine for the CHANGE USER; FIG. 5 is the WINDOW display for the change user; FIG. 6 is the WINDOW display for the creation of the new user; FIG. 7 is the FIND routine; FIG. 8 is the WINDOW display for the find function; FIG. 9 is the subroutine for the OPTIONS; FIG. 10 is the WINDOW display for options; FIG. 11 is the DISPLAY TEXT routine; FIG. 12 is the DISPLAY OVERLAY routine; FIG. 13 is the DISPLAY NOTES routine; FIG. 14 is the DISPLAY SCORES routine; FIG. 15 is DISPLAY ARTICULATION routine; FIG. 16 is the STREAM AUDIO Choice routine WINDOW display for the interactive audio function where the user chooses interactive (user's iteration of the model's speech) or original mode of the video's inherent audio stream, i.e. the model's speech stream; FIG. 17 is the LISTEN/SPEAK routine; FIGS. 18-21 are the WINDOW displays for display notes, display overlay, listen/speak options and display articulation, respectively; FIGS. 22A-22E are the PREPARE USER NOTES routine; FIGS. 23A-23D illustrate the PREPARE SCORES routines.

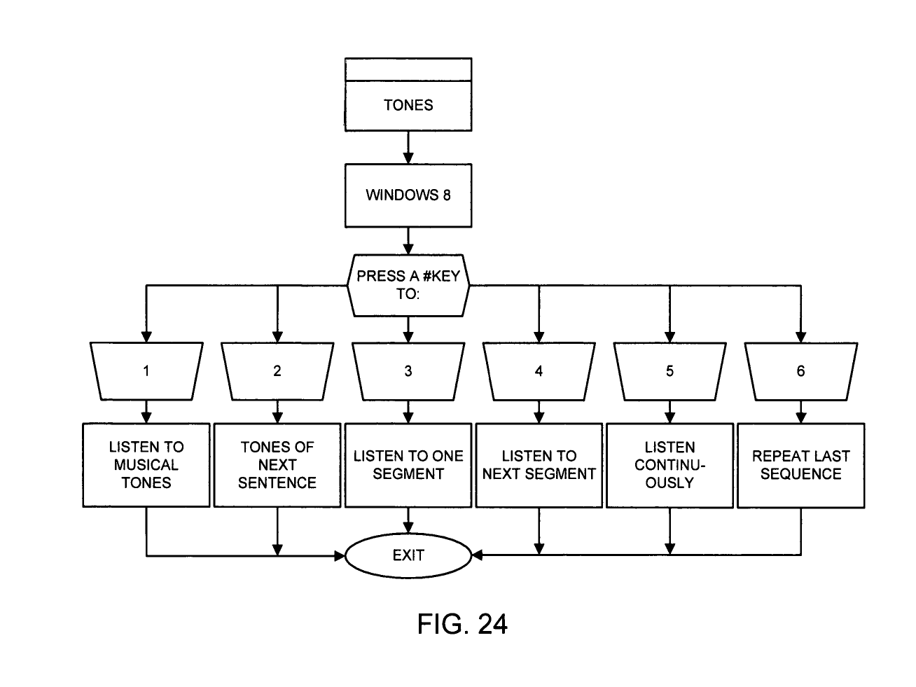

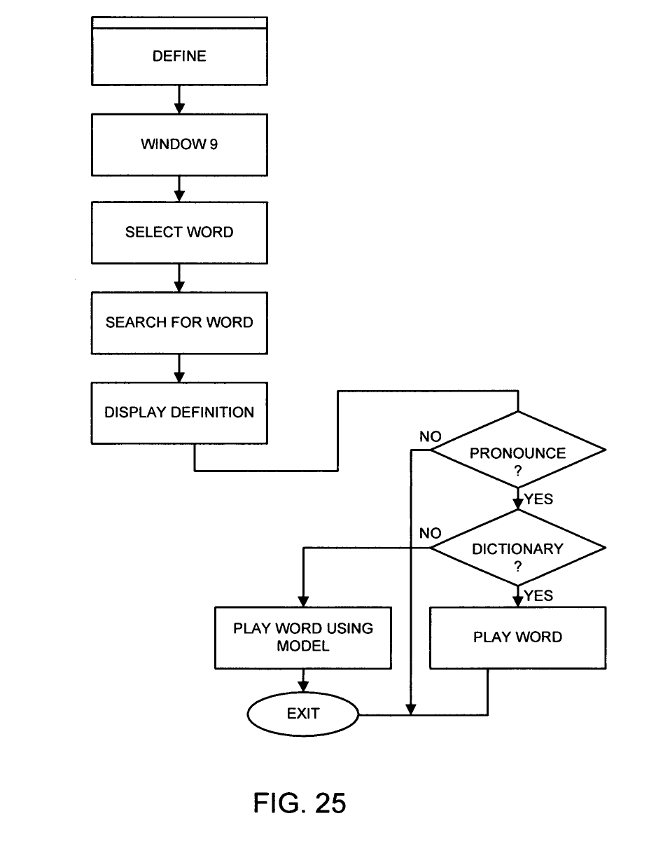

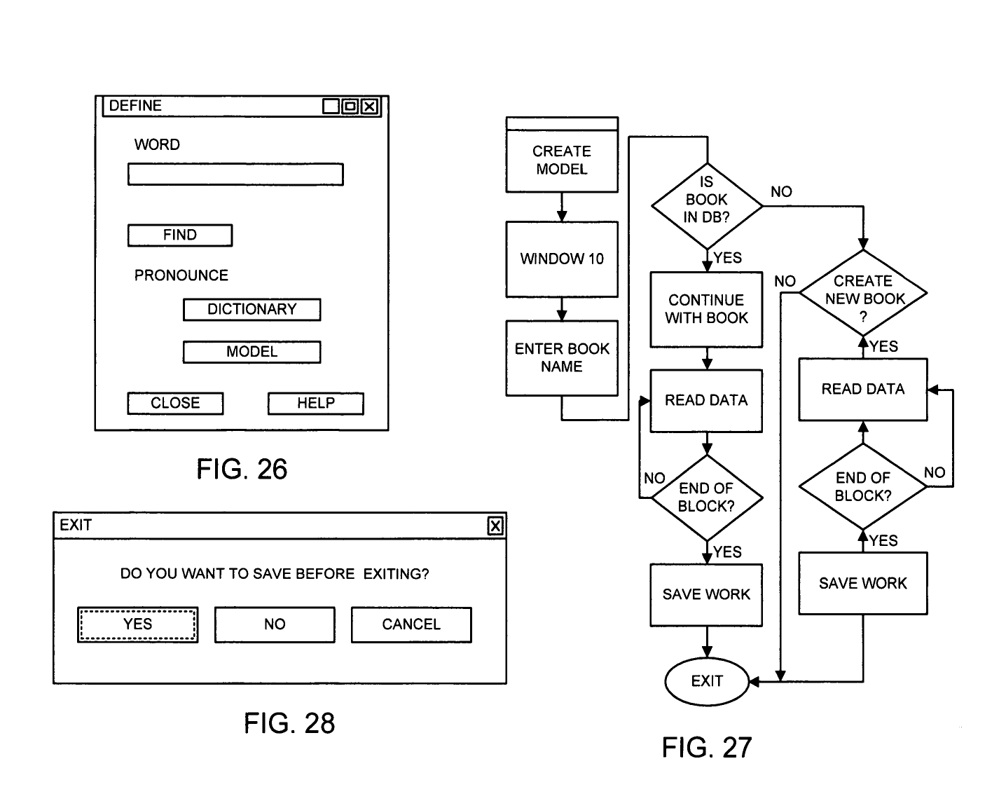

FIG. 24 is the TONES routine; FIG. 25 is the DEFINE routine; FIG. 26 is the WINDOW display for define; FIG. 27 is the CREATE CUSTOM MODEL routine, and FIG. 28 is the window display for EXIT. It should be noted that pressing the desired buttons/keys F1-F6 shown on the main menu WINDOW display (FIG. 3) initiates the routine corresponding to that key selection.

The present invention thus provides an improved computer assisted phonetic learning system wherein a student/user can easily compare the representation of his/her pronunciation of words with that of a model speaker and also be provided with a score illustrating the comparison of, in percentage terms, of the differences. The process of pressing a key (FIGS. 17 and 22) while speaking each accented syllable links and aligns the student's recorded stream of speech to that of a model speaker and to the written text which is read. This alignment greatly facilitates the calculations which are the basis for the feedback on pronunciation provided to the student.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. An interactive pronunciation learning system comprising:
a microprocessor;
a data input device coupled to said microprocessor to enable a user to interact with said microprocessor;
a display device coupled to said microprocessor to enable the user to visually compare his/her speech characteristics with that of a model speaker;
a speech processor for recording and linking the continuous speech of said user reading a body of embedded video captions, said speech processor being coupled to said microprocessor;
an audio device coupled to said speech processor for receiving the continuous stream of speech from said model speaker reading the same body of displayed text read by said user; means for connecting the output of said speech processor to a hearing device, the user thus being able to both visually and audibly compare his/her speech characteristics to that of the model speaker's; and
means for mathematically comparing the phonetic and phonemic elements of the acoustic waveforms of the two linked speech segments and displaying the results for each line of text at the user's option, segments of the user's digitally recorded speech being marked and analyzed and compared to each equivalent segment of the model speaker's speech wherein each of said segments comprises one accented syllable and is about three syllables in length.

2. The interactive pronunciation learning system of claim 1 wherein numeric scores are provided rating the correspondence of all the prosodic/phonemic elements on each line, paragraph and/or page.

3. The interaction pronunciation learning system of claim 1 wherein a segment of speech of the model speaker or user is replayed as recorded or optionally as only tones of the detected pitch, volume and duration.

4. The interaction pronunciation learning system of claim 1 wherein the correspondence for each speech segment is based on the dimensions of pitch, volume, duration and phonemic accuracy of the user's speech waveform.

5. A method for implementing an interactive pronunciation learning system comprising the steps of:
providing a microprocessor to enable a user to interact therewith;
having the user visually compare his/her speech characteristics with that of a model speaker;
recording and linking the continuous speech of said user reading a body of displayed text;
receiving the continuous stream of speech from said model speaker reading the same body of displayed text read by said user;
visually and audibly comparing the speech characteristics of the user to that of the model speaker's; and
mathematically comparing the phonetic and phonemic elements of the acoustic waveforms of the two linked speech segments and displaying the results for each line of text at the user's option, segments of the user's digitally recorded speech being marked, analyzed and compared to an equivalent segment of the model speech, wherein each of said segments comprises one accented syllable and is about three syllables in length.

6. The method of claim 5 further including the step of providing numeric scores ruling the correspondence of all the prosodic/phonemic elements on each line, paragraph and/or page.

7. The method of claim 5 further including the step of replaying as recorded a segment of speech of the model speaker or user or optionally as only tones of the detected pitch, volume and duration.

8. The method of claim 5 wherein the correspondence for each speech segment is based on the dimensions of pitch, volume, duration and phonemic accuracy of the user's speech waveform.

9. The method of claim 5 further including the step of replacing extended segments of speech of the model speaker in the video track with equivalent segments of the user as recorded, linked, and synchronized.
